(19) United States
(12) Patent Application Publication
(10) Pub. No.: US 2017/0141486 A1
(43) Pub. Date: May 18, 2017

(54) ELECTRIC WIRE WITH TERMINAL

(71) Applicant: YAZAKI CORPORATION, Tokyo (JP)

(72) Inventor: Kazuki MANO, Susono-shi, Shizuoka (JP)

(73) Assignee: YAZAKI CORPORATION, Tokyo (JP)

(21) Appl. No.: 15/321,878

(22) PCT Filed: Jun. 19, 2015
(86) PCT No.: PCT/JP2015/067802

§ 371 Date: Dec. 23, 2016

(30) Foreign Application Priority Data
Jun. 25, 2014 (JP) 2014-129919

(51) Int. Cl. H01R 4/18; H01R 4/62

(52) U.S. Cl. CPC H01R 4/185; H01R 4/62

(57) ABSTRACT

An electric wire with terminal (1) includes an electric wire (W) and a terminal (T) electrically connected to the electric wire. The electric wire with terminal includes at least one selected from a group consisting of: a first anti-corrosion structure configured to provide a ceramic layer (40) having a thickness from 1 μm to 200 μm so as to internally contain a connection part of a conductor (10) of the electric wire and the terminal; and a second anti-corrosion structure configured to connect the conductor (10) of the electric wire and the terminal (T) through a conductive ceramic layer having a thickness from 1 μm to 200 μm.

### TECHNICAL FIELD

The present invention relates to an electric wire with terminal.

### BACKGROUND ART

An electric wire with terminal, in which aluminum is used as a conductor, has been proposed in the background art. This electric wire with terminal is lighter in weight and lower in cost than one in which copper is used as a conductor. However, due to a difference in natural potential between a material used for the terminal (generally copper) and aluminum, corrosion (so-called galvanic corrosion) may occur in the conductor when electrolyte adheres to a contact part between the terminal and the conductor.

Hence, in one background-art electric wire with terminal, a water cut-off seal material such as silicone rubber is provided on the inside surface of the terminal in advance, and the terminal and a conductor are crimped so that the conductor can be entirely enclosed by the water cut-off seal material. Thus, electrolyte etc. can be prevented from invading a contact part between the conductor and the terminal, so as to prevent corrosion in the conductor (for example, see Patent Literature 1).

### CITATION LIST

### Patent Literature

Patent Literature 1: JP 2013-80682 A

### SUMMARY OF THE INVENTION

### Problems to be Solved by the Invention

In the aforementioned background-art electric wire with terminal, in order to satisfactorily prevent corrosion in the conductor, it is necessary to design the shape of the terminal so as to cover the conductor entirely therewith. Hence, the shape of the terminal has to be determined in accordance with the shape of the conductor. Thus, the degree of freedom in designing the shape of the terminal is low. Further, in the electric wire with terminal, in order to secure satisfactory water cut-off performance, it can be considered that it is difficult to make the water cut-off seal material thinner. As a result, the terminal itself is made larger (thicker) due to the thickness of the water cut-off seal material. In some case, there is a possibility that terminal is hardly attached to a target to which the terminal should be attached (for example, the terminal cannot be inserted into a cavity of a connector).

In consideration of the aforementioned problem, an object of the invention is to provide an electric wire with terminal, capable of preventing corrosion in a conductor of the electric wire while keeping, as high as possible, the degree of freedom in designing the shape of the terminal and the compatibility of the terminal with a target to which the terminal should be attached.

### Means for Solving the Problem

In order to attain the foregoing object, an electric wire with terminal according to the invention is characterized by including:

An electric wire with terminal comprising an electric wire and a terminal electrically connected to the electric wire, the electric wire with terminal including at least one selected from a group consisting of: a first anti-corrosion structure configured to provide a ceramic layer having a thickness from 1 μm to 200 μm so as to internally contain a connection part of a conductor of the electric wire and the terminal; and a second anti-corrosion structure configured to connect the conductor of the electric wire and the terminal through a conductive ceramic layer having a thickness from 1 μm to 200 μm.

When the first anti-corrosion structure is used in the electric wire with terminal according to the invention, the connection part in which the conductor and the terminal have been connected to each other is covered with the ceramic layer. It is hence unnecessary to determine the shape of the terminal so as to cover the conductor entirely therewith. On the other hand, when the second anti-corrosion structure is used, it will go well if the ceramic layer is present at least in the part where the conductor and the terminal are opposed to each other. It is unnecessary to determine the shape of the terminal so as to cover the conductor entirely therewith. Thus, the degree of freedom in designing the shape of the terminal is higher than in a background-art electric wire with terminal.

Further, according to experiments and considerations of the inventor, it has been proved that satisfactory water cut-off performance can be obtained in the case of the first anti-corrosion structure if the thickness of the ceramic layer is not less than 1 μm. It has been also proved that the thickness of the ceramic layer does not exceed a clearance (a gap between members defined at the time of design) with a general attachment target if the thickness of the ceramic layer is not more than 200 μm.

On the other hand, in the case of the second anti-corrosion structure, it has been proved that when the thickness of the conductive ceramic layer is not less than 1 μm, corrosion in the conductor is smaller in spite of electrolyte etc. invading the crimping part, compared with case where the conductor and the terminal are in direct contact with each other. In addition, it has been also proved that when the thickness of the conductive ceramic layer is not more than 200 μm, increase in electric resistance value of the electric wire with terminal caused by the existence of the conductive ceramic layer between the conductor and the terminal can be suppressed to an allowable degree (essential performance as the electric wire with terminal can be secured). In addition, in the same manner as in the first anti-corrosion structure, it has been also proved that the thickness of the ceramic layer does not exceed the clearance with a general attachment target when the thickness of the conductive ceramic layer is not more than 200 μm.

Further, as a result of experiments and considerations of the inventor, it has been also proved that when the thickness of the ceramic layer is made to be from 2 μm to 10 μm in the first anti-corrosion structure, the improvement of the water cut-off performance and the compatibility of the terminal with a target to which the terminal should be attached can be more suitably kept compatible. In addition, it has been also proved that when the thickness of the conductive ceramic layer is made to be from 2 to 10 μm in the second anti-corrosion structure, the improvement of the anti-corrosion performance in the conductor and increase in the electric resistance value of the electric wire with terminal can be more suitably kept compatible.

Accordingly, in the electric wire with terminal according to the invention, even when there is a large difference in natural potential between the conductor of the electric wire and the terminal, it is possible to prevent corrosion in the conductor of the electric wire while keeping, as high as possible, the degree of freedom in designing the shape of the terminal and the compatibility of the terminal with a target to which the terminal should be attached.

In the case of the first anti-corrosion structure, the ceramic layer may be formed from either a conductive ceramic material or an insulating ceramic material. On the other hand, in the case of the second anti-corrosion structure, the ceramic layer is formed from a conductive ceramic material in order to secure the electric connection between the conductor and the terminal.

In addition, the electric wire with terminal according to the invention may include both the first anti-corrosion structure and the second anti-corrosion structure. Specifically, the electric wire with terminal according to the invention may include an anti-corrosion structure formed as follows. That is, the part in which the conductor of the electric wire and the terminal have been crimped through the conductive ceramic layer having a thickness from 1 μm to 200 μm (preferably from 2 μm to 10 μm) is further covered with the ceramic layer having a thickness from 1 μm to 200 μm thick (preferably from 2 μm to 10 μm).

### Advantage of the Invention

According to the invention, it is possible to prevent corrosion in a conductor of an electric wire while keeping, as high as possible, the degree of freedom in designing the shape of a terminal and the compatibility of the terminal with a target to which the terminal should be attached.

### BRIEF DESCRIPTION OF THE DRAWINGS

FIG. 1 is an exploded perspective view of an electric wire with terminal according to an embodiment of the invention.

FIG. 2 is a partially enlarged perspective view of the electric wire with terminal according to the embodiment of the invention.

FIG. 3 is a perspective view showing an example of the electric wire with terminal according to the embodiment, showing a state in which both a conductor part and a terminal have been coated.

FIG. 4 is a table showing an evaluation result about the insertion performance to a connector and the anti-corrosion performance in each of examples and comparatives.

### MODE FOR CARRYING OUT THE INVENTION

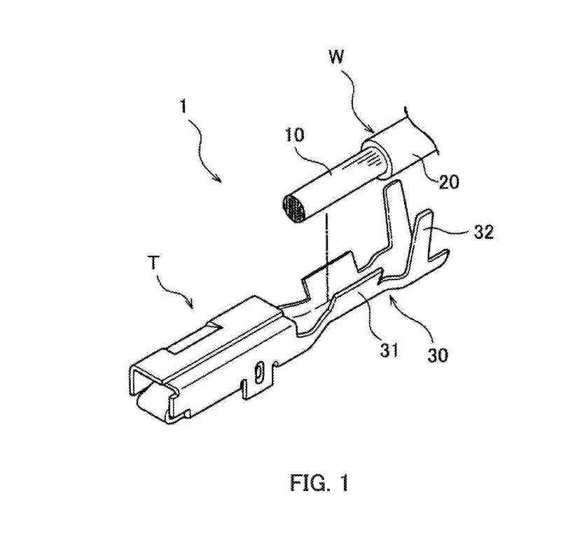

An electric wire with terminal (hereinafter referred to as “terminated electric wire 1”) will be described below with reference to FIGS. 1 to 4.

### <Structure of Terminated Electric Wire>

As shown in FIG. 1, the terminated electric wire 1 has an electric wire W and a terminal T. The electric wire W is constituted by a conductor 10 made from conductive metal (such as aluminum), and an insulating coating 20 covering the circumference of the conductor 10.

The terminal T is made from metal (such as copper), and provided with a connection part 30 for electrically connecting the conductor 10 of the electric wire W with the terminal T. The connection part 30 includes a conductor crimping part 31 for crimping the conductor 10 of the electric wire W, and a coating crimping part 32 for crimping the insulating coating 20 of the electric wire W. The conductor crimping part 31 and the coating crimping part 32 are separated from each other in the longitudinal direction of the terminal T. In addition, the conductor crimping part 31 and the coating crimping part 32 do not have to be two parts independent of (or separated from) each other, but they may be constituted by a single member having functions corresponding thereto.

The terminated electric wire 1 has at least one of the following anti-corrosion structures (1) and (2).

### (1) First Anti-Corrosion Structure

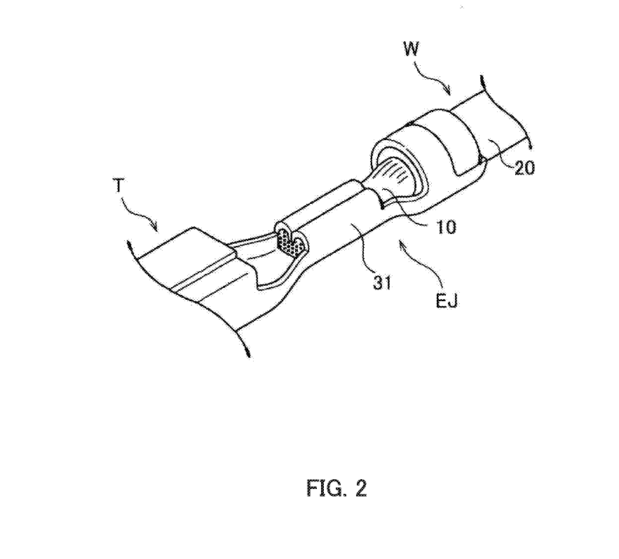

First, as shown in FIG. 2, the conductor 10 of the electric wire W is disposed in the connection part 30 of the terminal T, and the conductor crimping part 31 and the coating crimping part 32 are then caulked to crimp the terminal T and the conductor 10. Thus, the terminal T and the conductor 10 are electrically connected to each other.

Next, a ceramic layer not less than 1 μm thick and not more than 200 μm thick is provided to internally contain (cover) a connection part (electric connection part) EJ where the conductor 10 and the terminal T are in direct contact. Thus, a first anti-corrosion structure is formed. For example, the ceramic layer is formed to cover the whole of the conductor 10 exposed from the insulating coating 20 in FIG. 2 and, of the terminal T, a part adjacent to the conductor 10. A specific method for forming the ceramic layer will be described later.

### (2) Second Anti-Corrosion Structure

First, a conductive ceramic layer is formed in an inside surface of the terminal T (specifically, a surface that will be opposed to the conductor 10 when the terminal T and the conductor 10 are crimped as shown in FIG. 2) and/or an outside surface of the conductor 10 (specifically, a surface that will be opposed to the terminal T when the terminal T and the conductor 10 are crimped as shown in FIG. 2). The thickness of the conductive ceramic layer is determined to make the layer not less than 1 μm thick and not more than 200 μm thick between the terminal T and the conductor 10 after crimping, which will be described later.

Next, the conductor 10 of the electric wire W is disposed in the connection part 30 of the terminal T, and the conductor crimping part 31 and the coating crimping part 32 are then caulked to connect (crimp) the terminal T and the conductor 10 through the conductive ceramic layer. Thus, a second anti-corrosion structure is formed. For example, the conductive ceramic layer is formed to cover the whole of the outside surface of the conductor 10 exposed from the insulating coating 20 in FIG. 2, or the whole of the inside surface of the connection part 30 including the conductor crimping part 31 and the coating crimping part 32.

Examples of materials for forming the aforementioned ceramic layer and the aforementioned conductive ceramic layer may include nitride-based, oxide-based, carbide-based and carbon-based ceramic materials. More in particular, examples of the nitride-based ceramic materials may include titanium nitride, titanium carbonitride, chromium nitride, etc. Examples of the nitride-based ceramic materials may include aluminum oxide, silicon oxide, titanium oxide, yttrium oxide, etc. Examples of the carbide-based ceramic materials may include titanium carbide, silicon carbide, etc. Examples of the carbon-based ceramic materials may include amorphous carbon, etc. Of those materials, materials suitable for the first anti-corrosion structure and the second anti-corrosion structure (for example, in consideration of the magnitude of electric conductivity) may be selected.

For example, the material used for the ceramic layer in the first anti-corrosion structure may be either a conductive material or an insulating material. On the other hand, as the material used for the ceramic layer in the second anti-corrosion structure, a conductive material is used in order to secure the electric connection between the terminal T and the conductor 10.

Further, the thickness of the ceramic layer in the first anti-corrosion structure, and the thickness of the conductive ceramic layer in the second anti-corrosion structure are determined based on the experiments and considerations of the inventor. Specifically, in the case of the first anti-corrosion structure, the lower limit value is determined as 1 μm in consideration of satisfactory water cut-off performance, and the upper limit value is determined as 200 μm in consideration of a clearance of the terminal T with a general attachment target (in detail, see differences between examples and comparatives that will be described later).

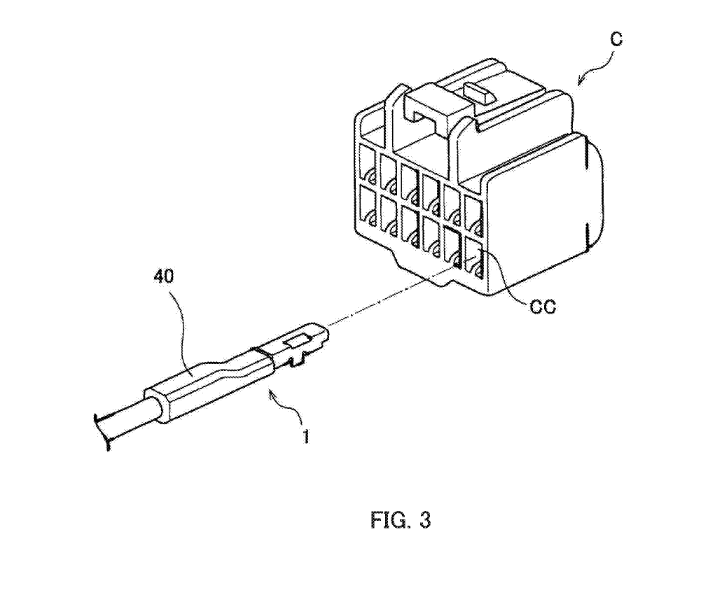

FIG. 3 shows a state in which the terminated electric wire 1 having the first anti-corrosion structure is inserted into a cavity (terminal reception chamber) C of a connector C that is one of attachment targets of the terminated electric wire 1. When the thickness of a ceramic layer 40 is within the aforementioned range, there is no fear that the ceramic layer 40 impedes the insertion even when the terminal T is inserted into the cavity CC as shown in FIG. 3.

On the other hand, in the case of the second anti-corrosion structure, the lower limit value is determined as 1 μm in consideration of the thickness by which corrosion in the conductor 10 can be reduced in comparison with a case where the terminal T and the conductor 10 are in direct contact when electrolyte etc. invades the crimping part, and the upper limit value is determined as 200 μm in the same consideration as in the first anti-corrosion structure.

### <Method for Forming Ceramic Layers>

A method for forming the ceramic layer in the first anti-corrosion structure and the conductive ceramic layer in the second anti-corrosion structure will be described. Those layers can be formed by a precipitation method or a thermal spraying method.

In the case of the precipitation method, first, a solution containing a predetermined ceramic material is prepared. Next, a target where a ceramic layer should be formed (for example, the conductor 10 of the electric wire W, the terminal T, or the connection part between the conductor 10 and the terminal T) is impregnated in the solution, and the ceramic material is precipitated by a composite plating method. Thus, the ceramic layer can be formed. In addition, one of electroplating, electroless plating, and displacement plating can be used in the composite plating method.

In the case of the thermal spraying method, a predetermined ceramic material is heated and melted, and the melted ceramic material is then sprayed to a target in which a ceramic layer should be formed. Thus, the ceramic layer can be formed. In addition, in the case of the thermal spraying method, the temperature with which the ceramic material is melted is very high, but the temperature with which the ceramic layer is formed can be kept at a comparatively low temperature (low temperature not to spoil the function as the terminated electric wire 1, for example, about 150° C.).

### <Evaluation of Terminated Electric Wire>

Examples and Comparatives for evaluating the properties of the terminated electric wire 1 will be described. In Examples and Comparatives, titanium oxide (conductive ceramic material) was used as the ceramic material. In addition, the first anti-corrosion structure was used as the anti-corrosion structure in Examples and Comparatives.

In each of Examples and Comparatives, a ceramic layer was formed (applied) by the precipitation method or the thermal spraying method, and insertion performance of the terminated electric wire 1 to an attachment target (a connector C having a cavity CC with a general size), and anti-corrosion performance were evaluated. Further, in Examples and Comparatives, terminals each having a connection part 30 in which a conductor crimping part 31 and a coating crimping part 32 were separated from each other (see FIG. 1. Such a terminal will be referred to as “normal barrel”), and terminals each having a connection part 30 in which a conductor crimping part 31 and a coating crimping part 31 were integrated (such a terminal will be referred to as “integrated barrel”) were used as the terminals T.

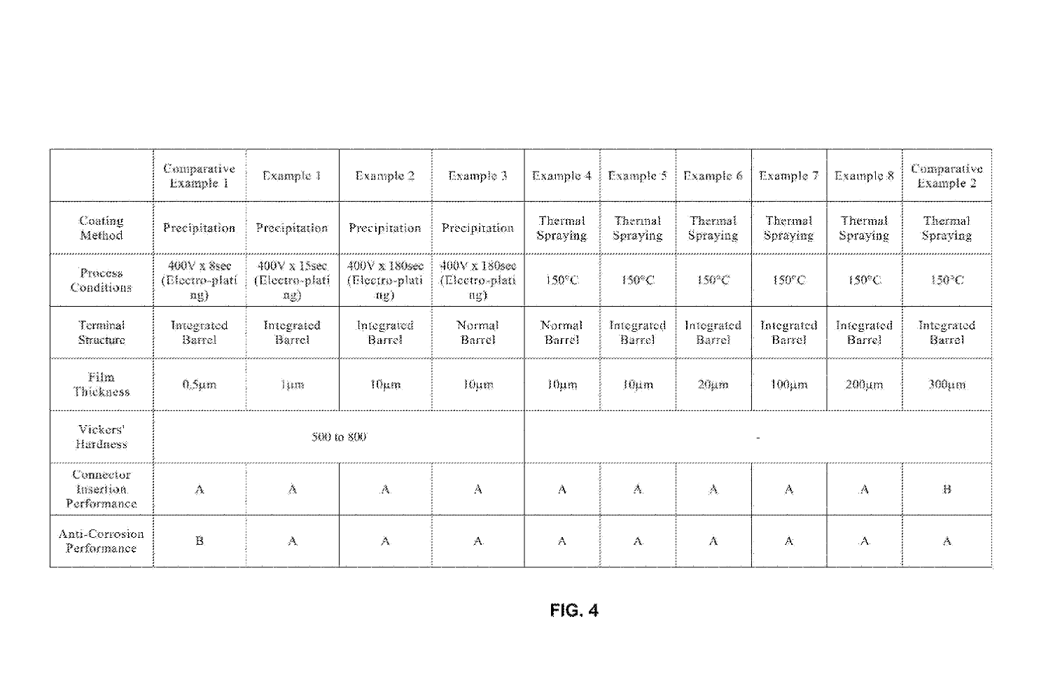

As shown in FIG. 4, ceramic layers were formed by the precipitation method using electroplating in Examples 1 to 3 and Comparative 1. On the other hand, ceramic layers were formed by the thermal spraying method in Examples 4 to 8 and Comparative 2. As for the shapes of terminals T, integrated barrels were used in Examples 1, 2 and 5 to 8 and Comparatives 1 and 2, and normal barrels were used in Examples 3 and 4. The thicknesses (film thicknesses) of the ceramic layers were set in a range of from 1 μm to 200 μm in Examples 1 to 8, at 0.5 μm in Comparative 1, and at 300 μm in Comparative 2.

As for criteria to evaluate insertion performance to a connector, each terminated electric wire 1 was evaluated as “A” when the terminal T (specifically, the ceramic layer covering the connection part between the terminal T and the conductor 10) could be inserted into the cavity CC of the connector C without touching a circumferential wall of the cavity CC, and as “B” when the terminal T touched the circumferential wall of the cavity CC so that the terminal T could not be inserted into the cavity CC.

As for criteria to evaluate anti-corrosion performance, each terminated electric wire 1 was left in a thermo-humidistat tank after a salt water spraying test (spraying 5% salt water for 96 hours at 35° C. atmosphere), and evaluated as “A” when corrosion could not observed in appearance, and as “B” when corrosion could be observed.

As a result of evaluation and from comparison between Comparative 1 and each Example 1 to 8, it was proved that satisfactory anti-corrosion performance can be obtained when the thickness of the ceramic layer is not less than 1 μm. On the other hand, as for the insertion performance to a connector, from comparison between Comparative 1 and each Example 1 to 8, it was proved that compatibility with a general connector is not spoilt when the thickness of the ceramic layer is not more than 200 μm.

Further, from comparison between Example 2 and Example 3 and comparison between Example 4 and Example 5, it was proved that a terminated electric wire 1 superior in connector insertion performance and anti-corrosion performance can be obtained using either an integrated barrel or a normal barrel (that is, independently of the shape of the terminal T).

As has been described above, the terminated electric wire 1 according to the embodiment includes at least one of the aforementioned first anti-corrosion structure and the aforementioned second anti-corrosion structure. Thus, it is possible to prevent corrosion in the conductor of the electric wire while keeping, as high as possible, the degree of freedom in designing the shape of the terminal and the compatibility of the terminal with a target to which the terminal should be attached.

Here, the aforementioned features of the terminated electric wire according to the invention will be summarized and listed briefly below.

That is, the aforementioned terminated electric wire 1 is an electric wire with terminal comprising an electric wire (W) and a terminal (T) electrically connected to the electric wire,

the electric wire with terminal (T) including at least one selected from a group consisting of: a first anti-corrosion structure configured to provide a ceramic layer (40) having a thickness from 1 μm to 200 μm so as to internally contain a connection part (30) of a conductor (10) of the electric wire and the terminal (T); and a second anti-corrosion structure configured to connect the conductor (10) of the electric wire and the terminal (T) through a conductive ceramic layer having a thickness from 1 μm to 200 μm.

Although the invention has been described in detail and with reference to its specific embodiment, it is obvious for those skilled in the art that various changes or modifications can be made on the invention without departing the spirit and scope of the invention.

For example, in the terminated electric wire 1 according to the invention, the terminal T may be a pressure-contact terminal in some application.

The present application is based on a Japanese patent application (Japanese Patent Application No. 2014-129919) filed on Jun. 25, 2014, and the contents of which are incorporated herein by reference.

### INDUSTRIAL APPLICABILITY

According to the invention, it is possible to prevent corrosion in a conductor of an electric wire while keeping, as high as possible, the degree of freedom in designing the shape of a terminal and the compatibility of the terminal with a target to which the terminal should be attached. The invention having the effect is useful for an electric wire with terminal.

### DESCRIPTION OF REFERENCE NUMERALS AND SIGNS

1 terminated electric wire
10 conductor
30 connection part
40 ceramic layer
T terminal
W electric wire

1. An electric wire with terminal comprising an electric wire and a terminal electrically connected to the electric wire,
the electric wire with terminal including at least one selected from a group consisting of: a first anti-corrosion structure configured to provide a ceramic layer having a thickness from 1 μm to 200 μm so as to internally contain a connection part of a conductor of the electric wire and the terminal; and a second anti-corrosion structure configured to connect the conductor of the electric wire and the terminal through a conductive ceramic layer having a thickness from 1 μm to 200 μm.
